(19) United States
(12) Patent Application Publication
(10) Pub. No.: US 2025/0316398 A1
(43) Pub. Date: Oct. 9, 2025

(54) SYSTEMS FOR RADIATION ABSORPTION USING ELECTRIC BLACKHOLES AND MEASUREMENT OF BLACKHOLE AND OTHER PROPERTIES

(71) Applicants: Ramesh Chandra, Fremont, CA (US); Monica Chandra, Fremont, CA (US)

(72) Inventors: Ramesh Chandra, Fremont, CA (US); Monica Chandra, Fremont, CA (US)

(21) Appl. No.: 18/435,502

(22) Filed: Feb. 7, 2024

Related U.S. Application Data
(60) Provisional application No. 63/454,875, filed on Mar. 27, 2023.

(51) Int. Cl. G21F 3/00; G01J 3/28; H01J 49/00; H01Q 17/00

(52) U.S. Cl. CPC G21F 3/00; G01J 3/28; H01J 49/0068; H01Q 17/00

(57) ABSTRACT

Robust designs for radiation absorption systems are described here that allows for efficient absorption over the widest range of electromagnetic frequencies. The radiation absorption systems have been designed that utilize photon capture by electrons that are primed to capture photons with maximum efficiency by maximizing the photon capture probability. Optimum potential fields along with very low temperatures and high pressure may be utilized for the purpose. Electric blackholes utilized make it possible to absorb electromagnetic radiation over the widest range of frequencies. The systems and techniques detailed here can also be utilized for measuring various properties of different types of blackholes such as gravitational, electric, and electro-gravitational blackholes. These techniques also allow us to track photon state after it gets absorbed by an atom.
Procedures/mechanisms are described for measurements of electronic collision relaxation time, effective mass of an electron, photon penetration depth, and Zero Inductance Electron Separation.

### RELATED U.S. APPLICATION DATA

Provisional Application No. 63/454,875, filed on Mar. 27, 2023

### FIELD OF THE INVENTION

There has been extensive work done to develop various techniques for radiation absorption that is of special significance for advancing stealth technology. Mechanisms such as pyramidal shaped rubberized foam impregnated with mixtures of carbon and iron, iron ball paint, Split-ring resonators (SRRs), and multi-walled nano tubes (MWNT) have been developed. However, all the systems developed so far are limited by the relatively narrow range of electromagnetic wave frequencies that can be absorbed and efficiency thereof. Therefore, there is a need to develop a more robust radiation absorption system that would be able to absorb the widest range of frequencies with desirable efficiency. So, we have devised a system that would employ a radically different approach that would use electric blackholes to absorb the widest range of frequencies associated with electromagnetic waves with high efficiency.

### BACKGROUND

Radiation-absorbent material (RAM) has been in usage for several decades. RAM is specifically designed and shaped to absorb incident RF radiation efficiently from multiple directions. Usually, materials used are neither good electrical conductors nor good electrical insulators. Pyramidal structures, usually made of rubberized foam impregnated with mixtures of carbon and iron have been used for radiation absorption. Pyramidal structures are used to degrade radiation through multiple scattering and absorption. Incoherent scattering also occurs within the foam itself in which carbon particles cause destructive interference. The pyramid is shaped at angles to cause maximum number of bounces for maximum degradation of the incident radiation. Flat tiles of ferrite materials have also been used but they seem to be effective only at lower frequencies (30-1000 MHz). So, hybrid systems comprising pyramidal ferrite material have also been used to maximize the frequency range.

Lockheed F-117 Nighthawk uses iron ball paint for stealth. It uses tiny spheres coated with carbonyl iron or ferrite. The oscillating magnetic field of Radar waves induce molecular oscillations in the tiny balls leading to generation of heat. This heat, in turn, is dissipated to the environment. The Israeli company Nanoflight also uses nano particles in their paint for radiation absorption.

Split-ring resonators (SRRs) represent a promising technology for

radiation absorption. It uses artificially produced metamaterials designed to produce magnetic response to incident radiation. It uses photographic process to create a resist layer on a thin copper foil with a dielectric backing using etched tuned arrays of resonators. These resonators are etched into a “C” shape. Sometimes a square shape is used. These resonators can be tuned to a specific frequency. Individual resonators are insulated from each other.

Another radiation absorbing technique involves usage of multi-walled nano tubes (MWNT) to absorb microwaves used by Radar. These nanotubes may be painted on the surface of a plane to reduce its Radar cross section. These nanotubes neither reflect nor scatter visible light.

### BRIEF SUMMARY OF THE INVENTION

Electromagnetic radiation absorption devices described here employ an electrostatic blackhole that has properties very similar to those of the well-known gravitational blackhole. Electromagnetic radiation incident within the blackhole boundary would not escape this blackhole. Several mechanisms/configurations are described here to achieve this objective. Trapped secondary stimulated radiation may leak but only to a very small distance. The mechanisms described herein are effective over the widest range of electromagnetic wave frequencies. Since the electric blackhole described here has properties that are similar to those of gravitational blackhole, it also allows us to study/measure various attributes of a gravitational blackhole.

### BRIEF DESCRIPTION OF THE DRAWINGS

Some of the embodiments of the present invention are illustrated as an example and are not limited by the figures of the accompanying drawings, in which like references may indicate similar elements and in which a reference to a figure refers to all its parts. In general, part B of a figure, herein, reveals the internal details of the system or component which may include a vertical cut up or cross section of the system or component. Explicit electrical connections are not part of the drawings herein. A brief description of the drawings is as follows:

FIG. 1 shows an electrostatic blackhole along with its blackhole boundary, light sources and radiation measurement instruments.

FIG. 2 shows an example of setup for charging of the blackhole.

FIG. 3 illustrates an example of a mechanism that can be utilized for efficient absorption of electromagnetic radiation with a wide range of frequencies.

FIG. 4A shows another example of device or mechanism for absorption of electromagnetic radiation with a wide range of frequencies. Here, we use highly compressed electron “gas” to help absorb the electromagnetic radiation of wide-ranging frequencies.

FIG. 4B shows the backside of the above said setup.

### DETAILED DESCRIPTION OF THE INVENTION

The terminology used herein is for the purpose of describing particular embodiments only and is not limiting of the invention. As used herein, the term “and/or” includes any and all combinations of one or more of the associated listed items. As used herein, the singular forms “a,” an,” and “the” are intended to include the plural forms as well as the singular forms, unless the context clearly indicates otherwise. It will be further understood that the term “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure will not be interpreted in an idealized or overly formal sense unless expressly so defined herein.

In describing the invention, it will be understood that number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Electrostatic blackhole, radiation absorption devices, apparatuses, concepts, and methods for producing various components, and features are discussed herein. In the following description, for purposes of explanation, numerous specific details are set forth in order to provide a thorough understanding of the present invention. It will be evident, however, to one skilled in the art that present invention may be practiced without these specific details.

The present disclosure is to be considered as an exemplification of the invention, and is not intended to limit the invention to the specific embodiments illustrated by the figures or description below.

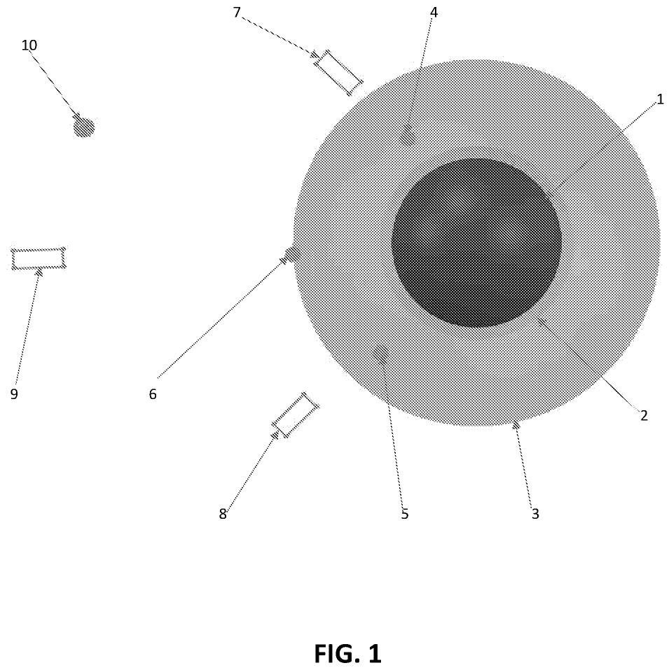

The present invention will now be described by referencing the appended figures representing preferred embodiments. As detailed later in the text, we would use an electric blackhole that is very similar to gravitational blackhole, to investigate and measure its properties and use these characteristics to design devices for efficient absorption of electromagnetic radiation over the widest range of frequencies. In FIG. 1, the electric blackhole comprises, as explained later in the text, highly compressed electron charges 1 that are enclosed in a completely transparent container 2. The underlying principle is detailed later in the text. Container 2 is made of a material that does not allow any reflection of electromagnetic (EM) waves. It may be noted here that the desired compression of electron charges is a challenging task but achievable. To achieve desired compression of electron charges, we may have to cool it to near zero-degree Kelvin. However, such a low temperature is not a prerequisite for its proper operation. We may achieve the same compression at much higher temperatures by encapsulating the electron charge in a fully transparent flexible pouch surrounded by highly pressurized electron “gas.” This can be further aided by negatively charged outer surface of the spherical, fully transparent enclosure even though it is not necessary and difficult to accomplish. As explained later in the text, electric blackhole boundary extends beyond the physical boundary of the said blackhole 1. In FIG. 1, this blackhole boundary is labeled as 3. It would be observed that if we place a light source 4 quite close to the physical boundary of blackhole 1, it cannot be seen by an observer outside the blackhole boundary 3. It is important to note here that this would happen only when this system is located inside a perfect vacuum. Perfect vacuum is essential to prevent propagation of light through cascading scattering by an atmosphere surrounding this blackhole. An ideal location for this setup would be in space that has no atmosphere. Otherwise, this setup will have to be placed in a sealed hall/room that has near-perfect vacuum. Radiation detectors/spectrometers 7, 8, and 9 are placed outside the blackhole boundary 3. Another light source 5 is placed at about radial distance r≈(2/3)r_{b} where r_{b} stands for the radius of the blackhole boundary 3. As explained later in the text, light from such a source is expected to reach just outside the blackhole boundary 3. Light from a source 6 placed at the blackhole boundary 3 would escape and can be detected far away from the electric blackhole 1. Spectrometers 7, 8, and 9 can be used to measure the red shift for various situations. In general, by moving light source to different locations (radial distances) inside the blackbody boundary 3, we can determine the escape ranges for emitted radiation. All this is explained later in the text.

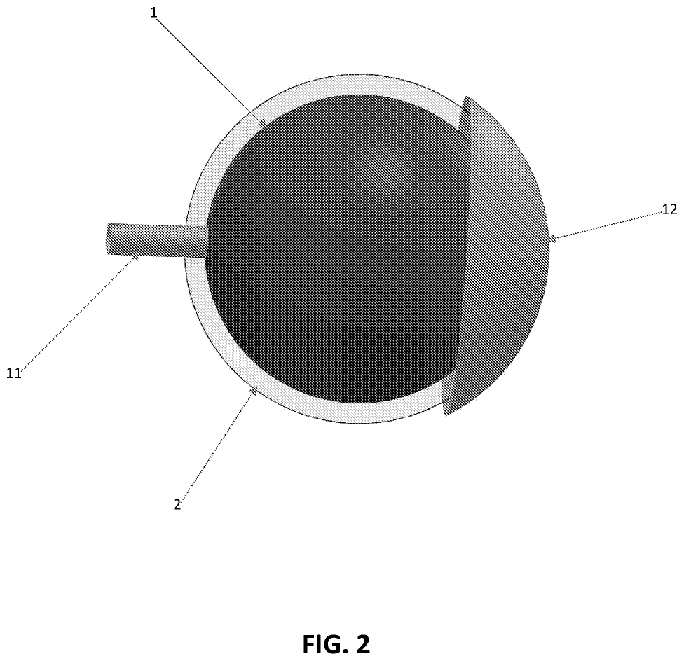

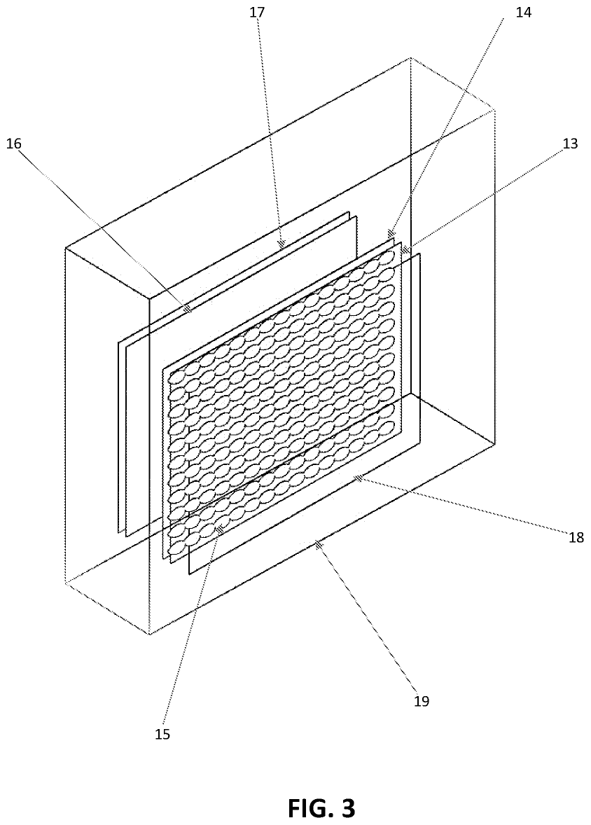

FIG. 2 illustrates an example of a mechanism for “charging” of the blackhole. Externally produced electrons are allowed to enter the totally transparent container 2 through tube 11. Here, the aim is to acquire a very large electron density inside container 2. However, as noted earlier, it is a rather challenging task to acquire the desired very large electron concentration. As noted above, it may require for the electron charges to be cooled to near absolute zero temperature and/or be squeezed by compressing the electron charges by applying intense pressure on it by surrounding it with highly pressurized electron “gas.” Such a mechanism is not explicitly shown here. Similar objective can be achieved by simply squeezing the volume containing the electron “gas.” To further help facilitate realization of this objective, a positively charged oval-shaped dish 12 may be used initially to attract electrons into spherical container 2. After completion of electron charge inside container 2, tube 11 is removed and the spherical container 2 is sealed. Finally, dish 12 is removed and discharged. Alternatively, it may be desirable to place a large positive charge, enclosed in a small spherical structure that is not explicitly shown in the figure, at the center of the spherical structure 2 that would allow electrons to aggregate toward the center. After attaining sufficiently large electron concentration, the positive charge in the center may be removed thereby facilitating a very large electron concentration inside the spherical structure 2. It may be noted here that electron mass (aggregation) around a very large positive charge may lead to the undesirable superconductive behavior of the electrons due to effective mass of electron acquiring a vanishingly small value under certain critical conditions. In this context, it may be noted here that a more practical arrangement for superconductive behavior would be wherein a very large positive charge density in a cylindrical enclosure is surrounded by electrons in an outer cylinder. Here, densely aggregated electrons in the outer cylinder should be expected to exhibit superconductive behavior if the positive charge density inside the smaller cylinder reaches a critical value. Similar superconductive behavior should be expected even without the presence of the positive charge in the inner cylinder provided electrons are squeezed to very high density so that binding begins to occur. This can be further aided by subjecting electrons to extremely low temperatures. In any case, superconductive behavior should be avoided as it is not conducive to radiation absorption. In this context, it may be noted here that under certain circumstances wherein the effective mass may become negative due to very large electric potential, it would amount to charge reversal. This is the subject of another patent application by us. Both the Coulomb as well as gravitational forces are long distance forces which change in character at extremely short distances. In reality there is only one force that manifests itself in different forms depending upon the circumstances. The ultimate reality is the electromagnetic force that changes its characteristics that depend upon the circumstances.

So, we need to assess the desired/optimum electron concentration, temperature, and pressure needed for efficient absorption of radiation. For this, measurement of the specific self-inductance ( [symbol] ) of the electron “gas” would reveal valuable information regarding the penetration depth which is proportional to [symbol] . In addition, since [symbol] is proportional to the effective mass (\tilde{m}ₑ) of electron and inversely proportional to electron concentration, measured value of specific self-inductance can be utilized to determine the effective mass of the electron. In turn, it can also be used to identify superconductive or near-superconductive state that are characterized by a vanishingly small value for the effective mass of an electron. The electron separation distance of the neighboring electrons determines the effective mass because the potential is directly controlled by this separation distance. Let us call this critical separation distance that leads to zero specific self-inductance as the “Zero Inductance Electron Separation” or “ZIES” for short. So, when the neighboring electron separation is close to ZIES, it would lead to superconductivity. To measure ZIES, we need to vary the electron concentration until the specific self-inductance of the electron “gas” becomes vanishingly small signaling the superconductive state. Then from the corresponding electron concentration, we can determine ZIES. However, it is important to note that the value of ZIES would change in presence of a positive potential that, for example, may be caused by nearby positive charges. Interference by the presence of positive charge may require a larger electron concentration to achieve the superconductive state. However, for the pure electron “gas” under discussion, its value is fixed and allows for the possibility of the undesirable superconductive state under very narrow range of neighboring electron separation. It appears, based on available data, that ZIES is orders of magnitude larger than the electron electric blackhole boundary radius. It is important to avoid the superconductive state because it is not conducive for radiation absorption. If we use a series R-L circuit to measure specific self-inductance, we can also directly measure the relaxation time for electron collisions inside the electron “gas” by simply measuring the time-constant. So, the electron concentration should be chosen that would yield large penetration depth that would correspond to large value of the specific self-inductance of the electron “gas.” The specific self-inductance, being proportional to the effective mass of electron, can be controlled by using the controlling parameters such as electron concentration, desirable low temperatures, and desirable high pressures. Finally, all these controlling parameters are utilized to achieve the desired separation distance among nearby electrons. This separation distance must be such as to allow incoming photons to come within the electric blackhole boundary radius of the electron so that they can be readily captured by electrons. It may be noted here that the electron electric blackhole radius itself would tend to increase due to the prevailing large electric potential that they would “experience.”

FIG. 3 shows an example of a mechanism for absorption of radiation over a very wide range of frequencies. As mentioned earlier and detailed later in the text, to achieve this objective, we would require a very large electron concentration. This is a very challenging task, but achievable. So, we would try to achieve maximum possible electron concentration to achieve acceptable level of radiation absorption. By applying a very large voltage between plates 13 and 14, we can make plate 13 acquire a large electron charge. To further enhance the electron concentration on plate 13, we can attach pouches 15 of highly compressed electron charge to this plate. Radiation is allowed to strike plate 13 through a perfectly transparent plate 18. As detailed later in the text, an electron behaves like an electrostatic blackhole, and therefore a very large electron concentration should be expected to absorb radiation very efficiently. As, detailed later in the text, as photons enter fully transparent plate 18, and head toward plate 13, if these photons are within the blackhole boundary of electron, they cannot escape this region. In addition, for |Ø₁/c²|<<1, if these photons encounter very large potential magnitude that would satisfy the condition −Ø₂/c²≥1/2, then the photons, due to strong redshift, cannot leave this region to go back toward plate 18. Here Ø₂ stands for the potential that exists in the region just entered by the photon and Ø₁ denotes the potential in the photon's original region. Furthermore, if the condition: 1−Ø₁/c²<−2Ø₂/c²<2 is satisfied, then the photon would not go back far into the originating region. Again, this is due to strong red-shifting during transitions from one region into the other. An explanation for these assertions is detailed later in the text. Since plate 13 carries a very large negative charge, it may be desirable to neutralize strong electric field by utilizing a shield against it on the other side. So, on the other side, we have a positively charged plate 17 to help achieve this objective. This plate can be made to acquire positive charge through application of voltage between plates 17 and 16 through a capacitive action. Finally, the entire system is enclosed inside completely transparent enclosure 19 that maintains very high vacuum inside to prevent any secondary emission/scattering.

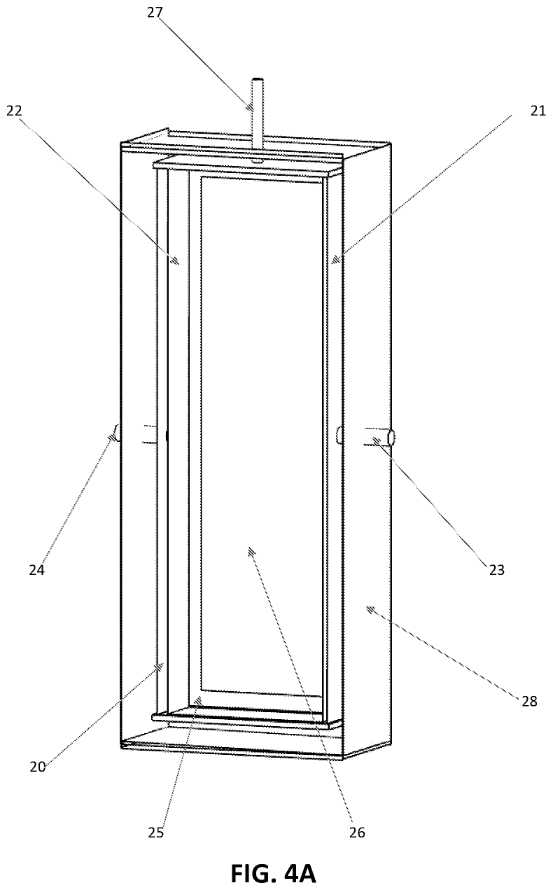

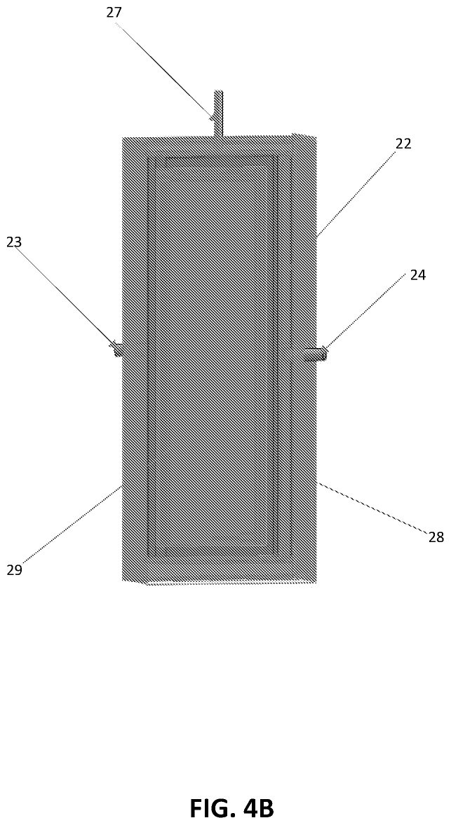

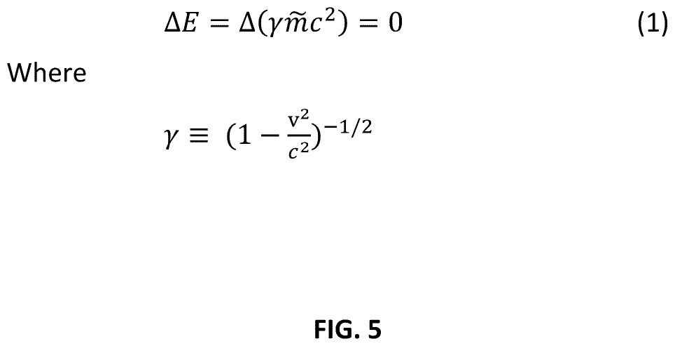

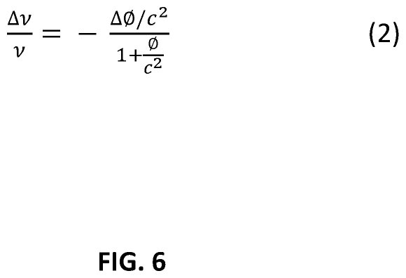

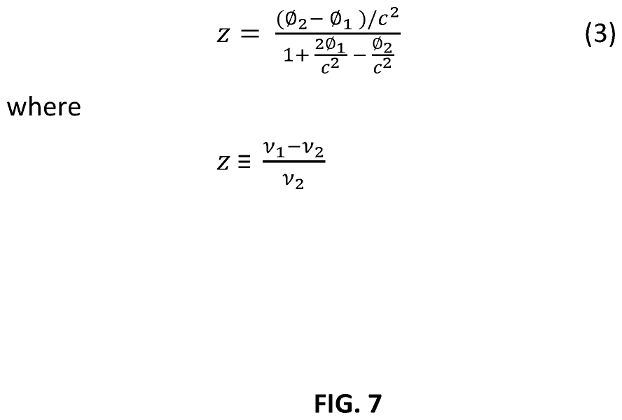

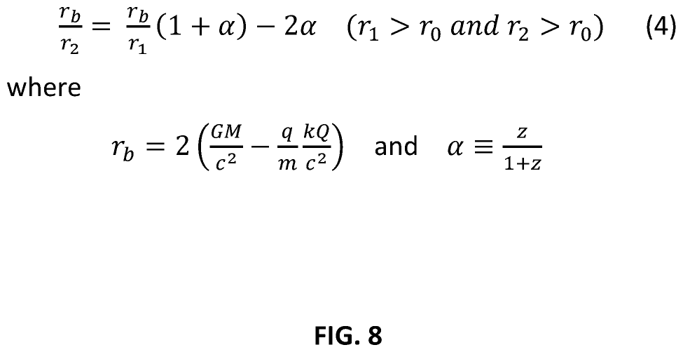

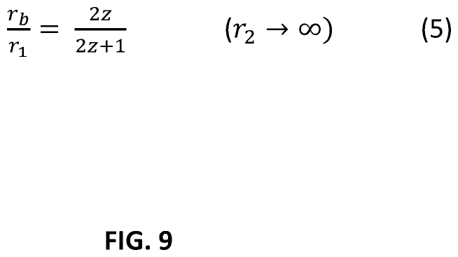

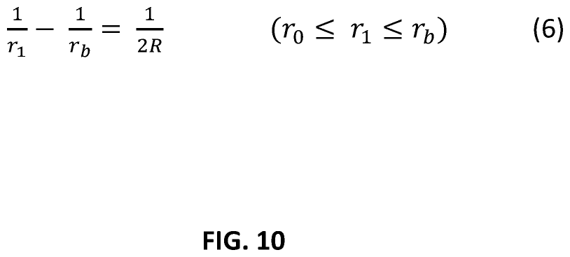

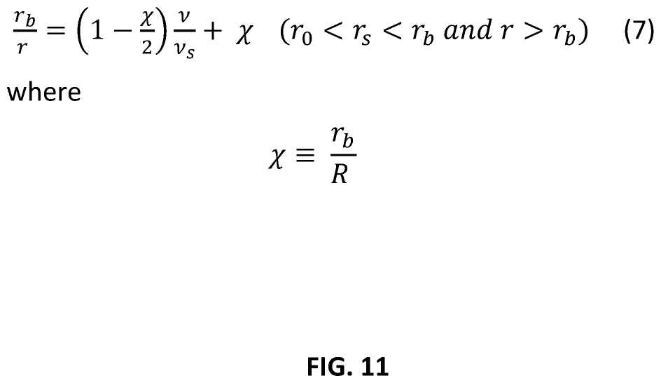

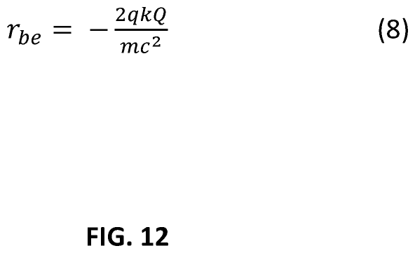

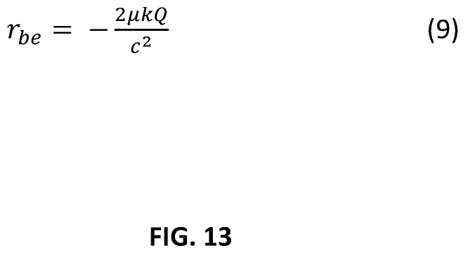

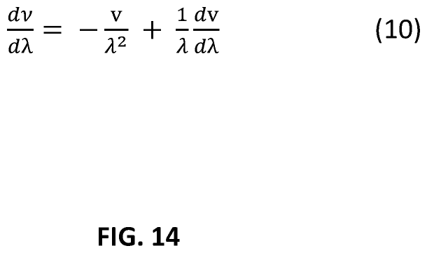

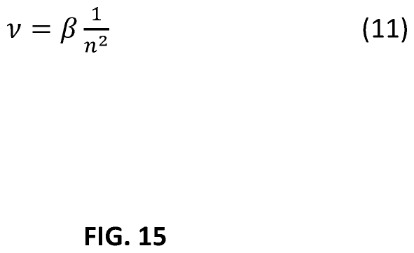

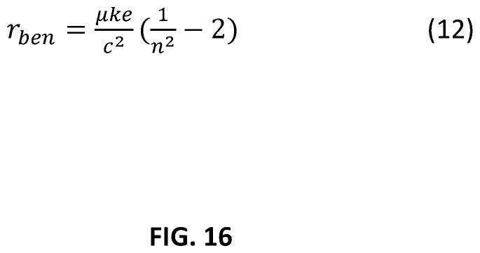

Another example of a mechanism for efficient absorption of radiation is shown in FIG. 4A. Here, we are illustrating the concept by using a rectangular sealed box 20 containing a suitable almost fully ionized gas. The gas gets ionized by applying the breakdown voltage across electrodes 23 and 24 which are electrically connected to the parallel side walls 21 and 22 respectively. Backside 26 of box 20 is made to acquire negative charge to attract positively charged ions and repel the electrons.

Gas is let into box 20 through tube 27. Electromagnetic radiation is allowed to enter the box through its front side 25 which is perfectly transparent. Maximum feasible electron concentration is used to achieve desired efficient absorption of incident radiation. As detailed later in the text, if an incident photon reaches within the electrostatic blackhole boundary of an electron, it gets captured by the electron. In addition, a large electron concentration with its consequential increase in electrostatic potential, would increase the blackhole boundary radius of an electron. Furthermore, as detailed earlier in the text, a very large potential magnitude “experienced” by an incident photon will not allow this photon to return back to its original environment. For this to happen, for the situation wherein |Ø₁/c²|<<1, the condition −Ø₂/c²≥1/2 or condition 1−Ø₁/c²<−2Ø₂/c²<2 must be satisfied as noted earlier in the text and explained later in the text. The backside wall 26 may be made to acquire negative charge through a capacitive action by applying suitable voltage between backside 26 and a parallel plate 29 in the back, as shown in FIG. 4B. Box 20 is enclosed inside a bigger rectangular box 28 which maintains a very high vacuum. The entrance wall of box 28 is made of perfectly transparent material.

Next, the physics/principles behind the operation of the above systems is briefly described here. The law of conservation of energy yields equation (1) as shown in FIG. 5. In Eq. (1) of FIG. 5, E, \tilde{m}, and v denote energy, effective mass, and speed of an object respectively, and c stands for speed of light in free space. If the object carries a charge q, and is subjected to gravitational as well as electric potential fields, then its effective mass \tilde{m} would be given by the expression: \tilde{m}c²=mc²+mØ^{(g)}+qØ^{(e)} where Ø^{(g)} and Ø^{(e)} denote the gravitational and electric potentials respectively and m stands for object's rest mass in free space.

Since frequency (ν) is proportional to γmc², equation (1) in FIG. 5 can be cast as that shown in FIG. 6 by Eq. (2). Here, Ø=Ø^{(g)}+(q/m)Ø^{(e)} and denotes the net potential energy “experienced” per unit mass. Notice that the relation in Eq. (2) of FIG. 6 is not an explicit function of the mass of particle, even though the presence of electric field makes it dependent on the ratio (q/m). Thus, as the wave associated with the object (particle) travels from a region characterized by potential (Ø₁) to a region with potential (Ø₂), it undergoes a redshift (z) as shown by Eq. (3) in FIG. 7. In FIGS. 7, ν₁ and ν₂ denote the frequency of original and observed waves respectively.

Assuming spherical geometry, relation shown in FIG. 7 can be rewritten as that shown by EQ. (4) in FIG. 8. In FIG. 8, M, G, k, and Q denote the external mass, the universal gravitational constant, electrostatic constant and external charge respectively. The electro-gravitational potential fields are caused by mass M and charge Q. r_{b} here stands for the blackhole boundary radius. For equation in FIG. 8, source of waves is at a distance r₁ from the center of object, and observation is made at a distance r₂ from the center of object. r₁ and r₂ both are assumed to be outside the spherical core (or bulk) of object with radius r₀. Here, we are referring to the object that is the source of the electro-gravitational fields. For observations very very far away (r₂→∞), equation (4) in FIG. 8, would yield: r_{b}/r₁=2z/(2z+1) as shown by Eq. (5) in FIG. 9. So, by measuring the redshift from a distant blackhole, we can determine the location of the source of radiation outside the boundary of the blackhole. This would allow us to map out the environment outside a blackhole.

Let us next consider a source of waves that resides within the boundary of a blackhole. To determine how far waves would escape under these circumstances, let us take the limit of equation in FIG. 8 as z→∞. This would yield the value of the maximum distance (R) traversed by the waves as shown by Eq. (6) of FIG. 10. Here R denotes the maximum distance traversed by radiation originating at a distance r=r₁ from the center of object. Here it is assumed that r₀≤r₁≤r_{b} and R>r_{b}, where r₀ denotes radius of the core of blackhole. This equation states that if the source is located at the boundary (r₁=r_{b}) of the blackhole then waves would escape (R→∞). However, as the source of waves moves below the boundary (r=r_{b}) toward the core, the maximum distance (R) decreases and moves toward the blackhole boundary. Since R represents the maximum distance to which waves escape, let us call this distance (R) as the range to which waves escape. This equation states that if the source of radiation is near but below the blackhole boundary, the range R>r_{b}. As the source moves closer and closer to blackhole boundary but in the region bounded by radial distance from r₀ to r_{b}, the range R moves further and further away from the blackhole boundary. This shows that waves do leak out through the blackhole boundary (r=r_{b}) for waves originating from region below the boundary but not too far from the boundary. However, these waves never reach the observer situated very very far away from the blackhole. And therefore, the object would still appear black to an observer who is situated very far away from the object. In fact, as long as the observer is situated at a distance greater than R from the center of this object, this object would still appear black to such an observer.

Let us recall Eq. (5) of FIG. 9. This relation shows that if the observer observes redshift (z)>>1, then the source of this radiation must be lying just outside the blackhole boundary. Let us further consider the situation wherein the core of the blackhole is located at r=r₀ so that the waves emanating from this core would escape up to range located at r=r₁ which is just outside the blackhole boundary. Under these circumstances, particle-waves are trapped between the core and the sphere of radius r₁ bouncing back and forth between the two spherical boundaries. This would lead to thermalization in the region that is bound by these two spheres. Therefore, such a blackhole may be a source of the well-known Cosmic Microwave Background (CMB) radiation with very high redshift (z˜1100) if the particle is the photon. It can readily be seen from equation (6) in FIG. 10 that location of this core is at r₀˜(2/3)r_{b}. Photon is supposed to have no detectable charge or mass but we can not say the same about the ratio (q/m) for photon. This topic will be discussed later in the text.

So, let the primary source of radiation be located at a radial distance denoted by rₛ inside a blackhole i.e., rₛ<r_{b}, and let r denote the point of observation outside the black object, i.e., r>r_{b}. Then replacing r₁ with rₛ, and r₂ with r in equation (4) of FIG. 8, and solving it for the observed frequency (v) at the point of observation at radial distance (r) from the center of blackhole, we get Eq. (7) in FIG. 11. Therefore, a plot of ν/νₛ vs 1/r would be a straight line. From this plot one can determine the range (R) of the leaked radiation by determining the intercept on the x-axis, and the y-intercept can be used to determine the value of χ and therefore that of the blackhole boundary radius r_{b}.

Since electrostatic force is much stronger than the gravitational force for ordinary mass value, we can ignore Ø^{(g)} and use the expression Ø=qØ^{(e)}/m in Eq. (4) shown in FIG. 8. This would modify the expression for the blackhole boundary radius as shown in Eq. (8) of FIG. 12 where Q stands for the electrostatic charge causing the electric potential Ø^{(e)} and k denotes the electrostatic constant. r_{be} in Eq. (8) of FIG. 12 denotes the blackhole boundary radius due only to the electrostatic field.

Let us recall that the blackhole boundary refers to the boundary that a photon emanating from inside the blackhole where mass or charge is situated, cannot cross. Photon is presumed to have no detectable “rest” mass or charge. However, we cannot say the same about the charge to mass ratio (q/m) for a photon. So, let us denote this ratio for photon as μ. Then Eq. (8) in FIG. 12 can be re-written as Eq. (9) shown in FIG. 13. So, the value of μ is needed to determine as to whether or not a charged object with charge Q is a blackhole. To determine μ, let us examine the consequences of its possible values on the known phenomena. Let us hypothesize that μ=−e/mₑ where e and me denote the electric charge and mass of an electron respectively. Then, for an electron, we would have: r_{be}=−2μke/c²=5.611×10⁻¹⁵ m which is twice the classical charge radius of an electron. Other estimates of electron size are significantly smaller than the classical charge radius. Therefore, it seems that electron must have characteristics of an electrostatic blackhole. This electron property plays an important role in designing systems that would absorb electromagnetic radiation efficiently.

Using Eq. (3) in FIG. 7, it is readily seen that if a photon enters from a region with potential Ø₁ into a region with potential Ø₂, then it cannot go far back into the starting region characterized with potential Ø₁ if the condition: 1−Ø₁/c²<−2Ø₂/c²<2 is satisfied. In addition, if the condition −Ø₂/c²≥1/2 is satisfied, then the photon will never return back into the original region with potential Ø₁. Here, we are assuming that |Ø₁/c²|<<1. It is readily verified that red-shifting does the trick. This observation plays a vital role in designing robust systems for the purpose of stealth. These type of systems for efficient radiation absorption have been described earlier in the text.

To design efficient radiation absorption systems, let us investigate the

behavior of this electron blackhole in presence of an external field such as that associated with a proton. Hydrogen atom is an example of this situation. Let us start with the well-known relation: ν=v/λ and differentiate it to get Eq. (10) as shown in FIG. 14. Integration of this equation yields a useful equation (11) of FIG. 15 where β represents the integration: (−1/λ₀²)∫v dλ. In deriving Eq. (11) in FIG. 15, it is assumed that v<<1 while photon gets absorbed by electron and its wavelength shrinks to λ₀ or its integral multiples so that λ=nλ₀ where n is a positive non-zero integer. The bounding space inside electron blackhole boundary leads to this relationship.

It seems that energy state of an electron inside hydrogen atom is associated with energy of the absorbed photon. Correlating the two, we get a value for β=ke²/2ah=3.282×10¹⁵ Hz using the well-known relation E=hv where E denotes the energy. Here, a stands for the Bohr radius. This implies that the electron blackhole boundary radius in the ground state is equal to the electron classical charge radius. For this situation, r_{be}=−2μke/c²≅−(2μa/c²)Ø^{(e)}. So, Δr_{be}=−(2μa/c²)ΔØ^{(e)}=−(2μa/c²)hv=−(2μa/c²)hβ(1/n²). So, finally, we can write a very useful expression for the electron blackhole boundary radius r_{ben}=r_{be}+Δr_{be} as shown in equation (12) of FIG. 16. It is evident from Eq. (12) in FIG. 16 that the electron black hole radius (r_{ben}) in the ground state doubles as electron transits into free space away from the nucleus. This would amount to waves being compressed by a constant factor to fit into the space between the core and the electron blackhole boundary. So, we can expect a linear relationship between inverse of wavelength (1/λ) and r_{be} and also between r_{be} and the corresponding core located at (r=r₀). So, let us write the linear equation for 1/λ vs. r_{be} as: 1/λ=mr_{be}+s where m and s denote the slope and the γ-intercept respectively. Differentiating this equation with respect to λ, we get: λ=[−(1/m)dλ/dr_{be}]^{1/2}. If waves inside the blackhole are compressed by a factor of j, then the core radius (r₀) would be: r₀˜(jm/s²+1)r_{be}−j/s. For the hydrogen atom, the two graphs of 1/λ vs. r_{be} as well as λ vs. r_{be} were plotted for the Lyman series of the hydrogen spectrum. For these plots, a value of 1 for j was used to be compatible with the classical size of an electron. Using these graphs, a value of 1.14×10⁻⁴ fm for λ is obtained. Therefore, a typical photon wavelength trapped between the electron blackhole boundary and the core would be 1.14×10⁻⁴ fm. A more detailed analysis for the Lyman series was carried out. Blackhole boundary radius (r_{be}) corresponding to different energy states range from 2.8060 to 5.4998 fm. As the electron blackhole boundary shrinks during transition of electron from higher energy state to the ground state, photon would completely escape because suddenly it would find itself outside the new shrunk electron blackhole boundary. Using the value of 1.14×10⁻⁴ fm for λ, it is readily seen that the photon inside electron blackhole boundary is crawling at a speed of about 3.33×10⁻⁴ m/s. Here, we are ignoring redshift as photon exits the electron blackhole boundary into free space. It is readily seen that this would yield a value of about 2.4×10⁻³⁵ Kg for the effective mass of photon inside the electron blackhole boundary.

Because of the leaked radiation, we should expect a little “glow” around the electron blackhole boundary which may make it visible because of secondary emission outside the electron blackhole boundary through usage of extremely high-resolution instruments. This glow can be made larger by subjecting electron to large positive potential field. This conclusion is due to Eq. (6) of FIG. 10 by observing that electron blackhole boundary radius tends to shrink under the influence of a positive charge nearby. Additionally, as detailed above, the electron blackhole may also be contributing to CMB if its core radius (r₀)˜(2/3)r_{be} as detailed earlier. The setup described in FIG. 1 may be used to validate these argument/assumptions.

What is claimed is:

1. Mechanisms for efficient radiation absorption over the widest range of electromagnetic frequencies using electric blackholes;
setting and implementing specific conditions for no escape of photons.

2. Simulation and measurement roadmap of various properties of different types of blackholes such as gravitational, electric, and electro-gravitational blackholes;
set up and methodologies are detailed herein to measure blackhole properties such as its blackhole boundary radius, radiation escape range as a function of location of the source inside a blackhole, blackhole core radius, identification of blackholes that may be contributing to the Cosmic Microwave Background (CMB) radiation.

3. Mechanism/method for determination of the effective mass of an absorbed photon by an electron and its blue-shifted wavelength;
mechanism/method for determination of the electric blackhole boundary radius of electron in presence of a nearby positive charge such as a nucleus;
mechanism/method for determination of the charge to mass ratio of a photon that seems to have vanishingly small mass and charge.

4. Mechanism/method for measurement of the effective mass of an electron;
mechanism/method for measurement of Zero Inductance Electron Separation (ZIES) for an electron “gas;”
mechanism/method for measurement of the photon penetration depth;
mechanism/method for direct measurement of the electron collision relaxation time.
